(19) United States
(12) Patent Application Publication
(10) Pub. No.: US 2010/0006579 A1
(43) Pub. Date: Jan. 14, 2010

(54) System and Method for Separately Holding Consumables

(76) Inventors: DONNA ROTH, PLYMONTH, MA (US); HENRY ROTH, PLYMOUTH, MA (US)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(21) Appl. No.: 12/172,203

(22) Filed: Jul. 11, 2008

(51) Int. Cl. A47G 23/04; A47J 39/02

(52) U.S. Cl. 220/592.01; 220/592.2

(57) ABSTRACT

A tray that may have at least one recess defining at least one consumable receiving cavity. The tray is configured to be seated generally at least partially within and/or over a opening of a main bowl with a lid placed thereover to engage the bowl and enclose the tray within the lid and the main bowl. Thermal energy storage material is preferably located in the tray.

### BACKGROUND

The present invention relates to containers and, more particularly, to containers and covers having a thermal energy storage material located therein and adapted to separately hold consumables, utensils and/or food accessories.

Thermal energy storage packs are generally known for use in maintaining the contents of a storage container in a heated or cooled state. For example, frozen thermal packs are pre-filled with a thermal energy storage material which can be frozen and then placed alongside food in an insulated container, such as a cooler, in order to maintain the cooler contents, such as food and drinks, in a cold state for a predetermined time period. Such thermal energy materials generally have 10-15 times the thermal capacity of frozen water and therefore maintain the cooler contents in a cold state for an extended period of time in comparison to ice alone. Such cold packs can be reused numerous times by refreezing them between use, and also avoid the problem of melting liquid contacting the items in the cooler. Energy storage materials which maintain heat are also known which can be preheated in a microwave, or through other means.

These heat or cold packs generally come in predetermined sizes which are not always convenient for a small quantity of food, such as a single person's meal. In addition, for a person desiring to transport only a single meal for later consumption, placing one or more food storage containers and a thermal energy storage pack alongside food in a cooler or box and storing utensils or other food accessories can be a significant inconvenience.

It may be advantageous to provide a container which includes one or more cavities for food storage, a compartment which holds thermal energy storage material, and/or that provides a convenient and attractive method for separately transporting consumables.

### SUMMARY

One embodiment of the present invention is directed to a system adapted to separately hold consumables including a main bowl having an upper perimeter portion defining an opening. A tray has at least one recess defining at least one consumable receiving cavity. The tray is configured to be seated generally at least partially within and/or over the opening of the main bowl. A secondary bowl is located in the at least one recess. The secondary bowl is adapted to receive at least one of a consumable and a container adapted to hold consumables therein. Thermal energy storage material is located in the tray and is adapted to heat and/or cool consumables. A lid is adapted to cover the tray and detachably engage the main bowl.

In another aspect, the present invention is directed to a system adapted to separately hold consumables including a main bowl having an upper perimeter portion defining an opening. A tray has at least one recess defining at least one consumable receiving cavity. The tray is configured to be seated generally at least partially within and/or over the opening of the main bowl. The container is adapted to hold consumables therein, the container being detachably engageable with the tray. A secondary bowl located in the at least one recess. The secondary bowl is adapted to receive at least one of a consumable and the container adapted to hold consumables therein. Thermal energy storage material is located in the tray and is adapted to heat and/or cool consumables. A lid is adapted to cover the tray and detachably engage the main bowl.

In another aspect, the present invention is directed to a system adapted to separately hold consumables including a main bowl having an upper perimeter portion defining an opening. A tray has at least one recess defining at least one consumable receiving cavity. The tray is configured to be seated generally at least partially within and/or over the opening of the main bowl. The tray is at least partially translucent and/or at least partially transparent. A container is adapted to hold consumables therein. The container is detachably engageable with the tray. A secondary bowl is located in the at least one recess. The secondary bowl is adapted to receive at least one of a consumable and the container adapted to hold consumables therein. Thermal energy storage material is located in the tray and adapted to heat and/or cool consumables. A lid is adapted to cover the tray and detachably engage the main bowl. A color of the thermal energy storage material can be seen through the tray.

In another aspect, the present invention is directed to a system adapted to separately hold consumables including a main bowl having an upper perimeter portion defining an opening. The main bowl has a ledge extending generally outwardly therefrom. A tray has at least one recess defining at least one consumable receiving cavity. The tray is configured to be seated generally at least partially within and/or over the opening of the main bowl. A container is adapted to hold consumables therein. The container is detachably engageable with the tray. A secondary bowl is located in the at least one recess. The secondary bowl is adapted to receive at least one of a consumable and the container adapted to hold consumables therein. Thermal energy storage material is located in the tray and is adapted to heat and/or cool consumables. A lid includes at least one tab extending therefrom. The at least one tab is adapted to engage the ledge to detachably secure the lid to the main bowl.

In another aspect, the present invention is directed to a tray having at least one recess defining at least one consumable receiving cavity. The tray is configured to be seated generally at least partially within and/or over a opening of a main bowl with a lid placed thereover to engage the bowl and enclose the tray within the lid and the main bowl. Thermal energy storage material is located in the tray.

In another aspect, the present invention is directed to a system adapted to separately hold consumables including a main bowl having an upper perimeter portion defining an opening. A tray has at least one recess defining at least one consumable receiving cavity. The tray is configured to be seated generally at least partially within and/or over the opening of the main bowl. A secondary bowl is located in the at least one recess. The secondary bowl is adapted to receive at least one of a consumable and a container adapted to hold consumables therein. A lid is adapted to cover the tray and detachably engage the main bowl.

### BRIEF DESCRIPTION OF THE DRAWINGS

The foregoing summary, as well as the following detailed description of the preferred embodiments of the present invention, will be better understood when read in conjunction with the appended drawings. For the purpose of illustrating the invention, there is shown in the drawings an embodiment which is presently preferred. It is understood, however, that the invention is not limited to the precise arrangement and instrumentality shown. In the drawings:

FIG. 1 is a perspective view of a system adapted to separately hold consumables according to a preferred embodiment of the present invention; The system preferably includes a main bowl, a tray, a secondary bowl, a container adapted to hold consumables, and a lid; The tray is seated generally at least partially within and/or over a opening of the main bowl; A secondary bowl is located on the second tray and is preferably surrounded by recesses that form consumable receiving cavities;

FIG. 2 is an exploded view of the system of FIG. 1 illustrating the tray detached from the main bowl and the container detached from the secondary bowl; The secondary bowl is preferably formed by the tray; Dividers are formed by the tray to create recesses that can serve as consumable receiving cavities; A flange that may extend around the container is shown and is configured to engage a groove that may be located along an upper inner surface of the secondary bowl;

FIG. 3 is a perspective view of a portion of the system of FIG. 1 illustrating the tray and main bowl holding consumables; More specifically, the main bowl is holding chips and the secondary bowl is holding dip; A protrusion may extend outwardly from the tray in an annular fashion for engagement with the main bowl;

FIG. 4 is a cross-sectional view of the system of FIG. 1 as taken along the line 4-4 in FIG. 1 and illustrates thermal energy storage material located within the tray; While the thermal energy storage material is shown as being generally located throughout the entire tray, the material may be located in just one or multiple discreet locations without departing from the scope of the present invention; The container is seated in the secondary bowl with the container configured such that the cover is generally adjacent to the upper edge of the tray when the container is engaged with the secondary bowl; The container may include a cover with grip around a perimeter thereof and with grooves in an upper surface that may form a handle;

FIG. 5 is an exploded view of one preferred construction of the tray of the system of FIG. 1; The tray may be formed by first and second panels that may be joined using sonic welding or any other suitable method; In some embodiments, the thermal energy storage material can be injected into the tray at an injection site that is then welded closed;

FIG. 6 is an enlarged, partial view of the tray and container of the system of FIG. 1; A groove may be located in an upper inner surface of the secondary bowl and a flange may be located along an outer surface of the container; The flange may be annular and extend generally outwardly from the container to engage the secondary bowl to form a snap fit connection; Any other suitable connection between the container and the secondary bowl may be used without departing from the scope of the present invention; and

FIG. 7 is an enlarged partial cross-sectional view of the container adapted for holding consumables detachably engaged with the secondary bowl; The secondary bowl is shown as being defined and/or formed by the tray; However, those of ordinary skill in the art will appreciate from this disclosure that the secondary bowl can be an independent component that is temporarily or permanently affixed to the tray without departing from the scope of the present invention.

### DETAILED DESCRIPTION OF THE PREFERRED EMBODIMENTS

Certain terminology is used in the following description for convenience only and is not limiting. The words “right,” “left,” “front”, “back,” “lower,” and “upper”designate directions in the drawings to which reference is made. The words “inwardly” and “outwardly” refer to directions toward and away from, respectively, the geometric center of the container and designated parts thereof. The language “at least one of ‘A’, ‘B’, and ‘C’,” as used in the claims and in corresponding portions of the specification, means “any group having at least one ‘A’; or any group having at least one ‘B’; or any group having at least one ‘C’;—and does require that a group have at least one of each of ‘A’, ‘B’, and ‘C’.” Additionally, the terms “a” and “one”, as used in the claims and in the corresponding portions of the specification, are defined as including one or more of the referenced item unless specifically stated otherwise. The term “utensil”, as used in the claims and in corresponding portions of the specification, means “any implement or food accessory used in (or with) the consumption of food or beverage items, including but not limited to a fork, a spoon, a knife, salt, pepper, a straw, chopsticks, or the like. The term “consumable”, as used in the claims and in corresponding portions of the specification, means “any item which is to be stored for later consumption or use, including but not limited to foods and beverages, including both items stored directly in the thermal energy storage system and items in separate packaging”. The above terminology includes the words above specifically mentioned, derivatives thereof, and words of similar import.

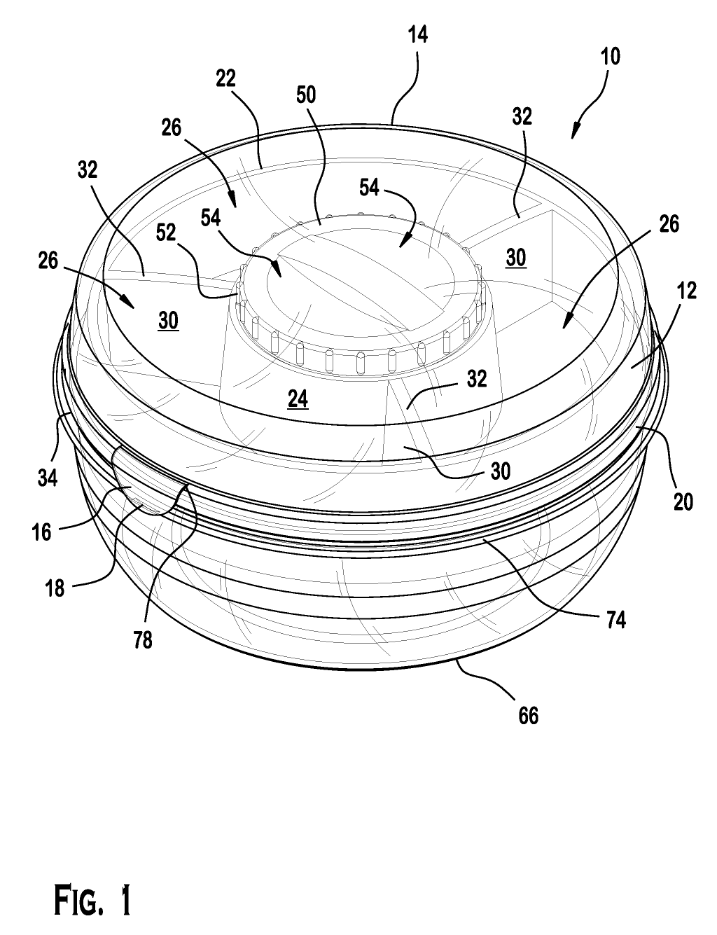

Referring now to FIGS. 1-7, wherein like numerals indicate like elements throughout, a preferred embodiment of a system 10 adapted to separately hold consumables according to the present invention is shown. Briefly stated, the system 10 includes a tray 22 that may have thermal energy storage material 62 therein. The tray can be positioned on a main bowl 64 and may also be able to receive a container 48 thereon. A lid 12 can be positioned over the tray 22 and engage the main bowl 64 to facilitate the secure separate transport of food items, at least some of which may be chilled or heated.

The system 10 and its component parts are preferably formed from a sturdy, non-reactive, durable material, such as a suitable polymer. The components of the system 10 may be formed of a polymeric material, such as polyethylene terephthalate (PET), polyvinyl chloride (PVC), polyphthalate carbonate (PPC), or the like. However, those of ordinary skill in the art will appreciate from this disclosure that the system 10 and its various components can be formed from any materials suitable for use with consumables. The thermal energy storing material 62 is preferably a gelatinous material that is formed of re-freezable material and/or re-heatable material, such as the non-toxic materials used in gel packs and the like. However, those of ordinary skill in the art will appreciate from this disclosure that any suitable thermal storing material can be used without departing from the scope of the present invention.

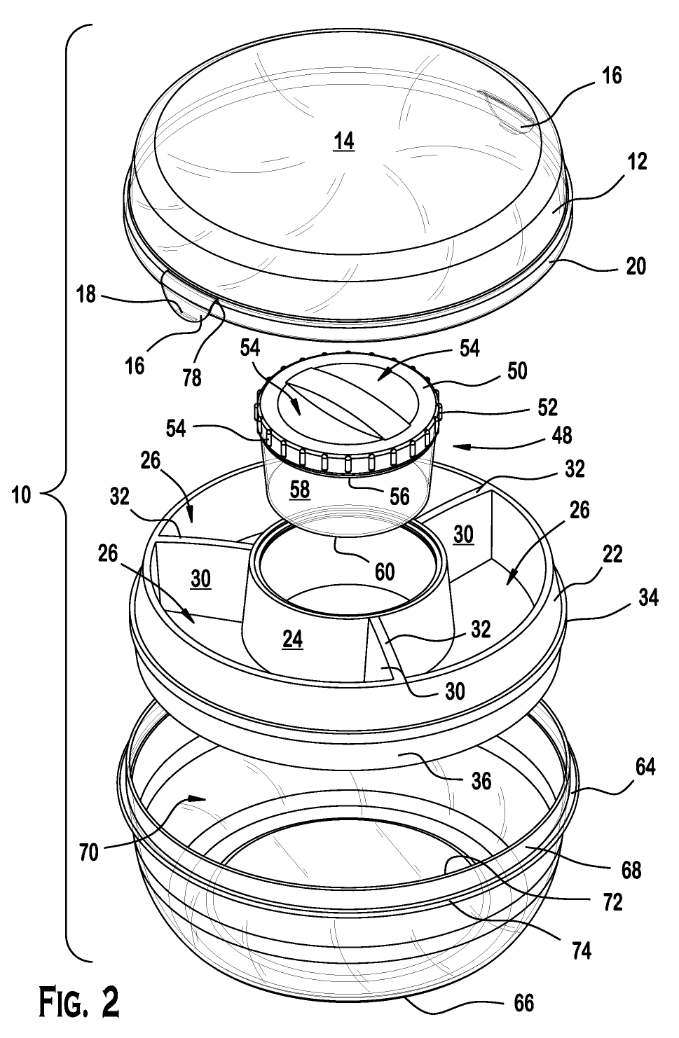

Referring to FIGS. 1 and 2, the system 10 may be adapted to separately hold consumables 76. The system 10 may include a main bowl 64 having an upper perimeter portion 68 defining an opening 70. It is preferred that the main bowl 64 have a generally circular shape when a horizontal cross section is viewed. The bowl 64 preferably extends through a generally outwardly convex curve as you move along the main bowl outer surface upwardly away from the base 66. The upper edge 72 of the bowl preferably, but not necessarily, provides a surface against which the tray 22 can be located. While the main bowl preferably has a generally circular shape, those of ordinary skill in the art will appreciate from this disclosure that the shape of the main bowl 64 can vary without departing from the scope of the present invention. For example, the main bowl 64 can be rectangular, oblong, irregular, square, or the like.

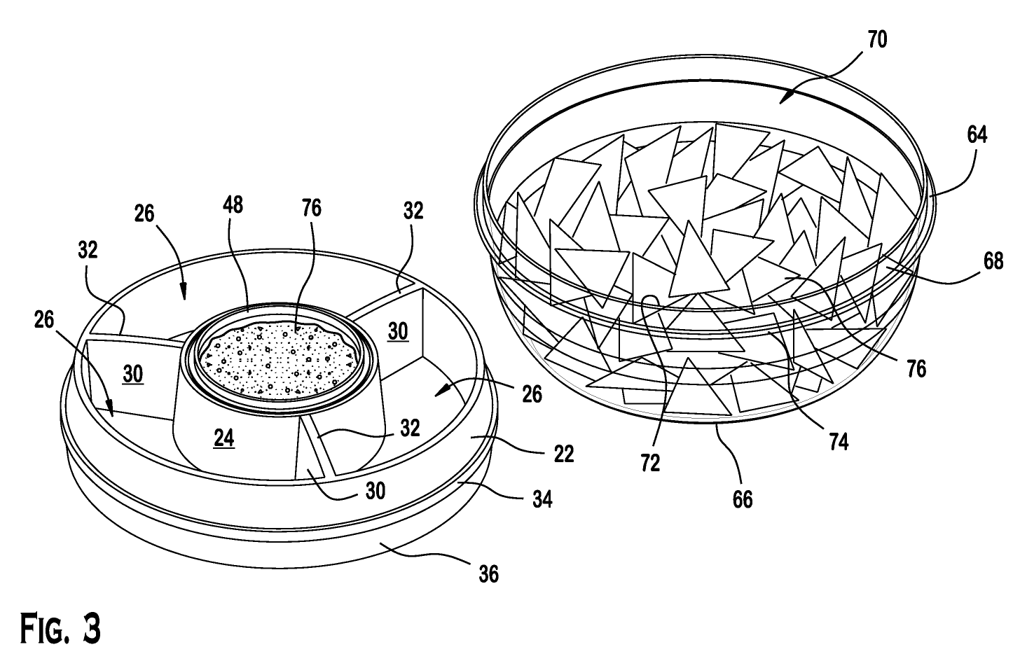

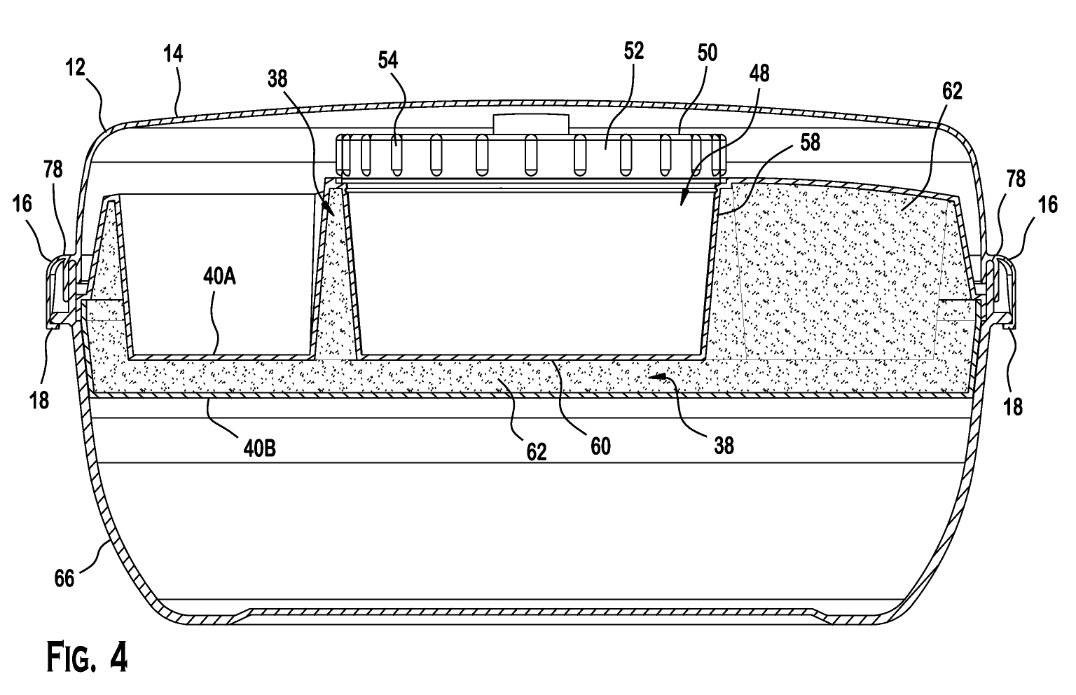

Referring to FIGS. 3 and 4, the main bowl 64 may have a ledge 74 extending generally outwardly therefrom to form a shoulder. The ledge 74 is preferably, but not necessarily, annular in shape and is configured to engage a lid 12 (further described below).

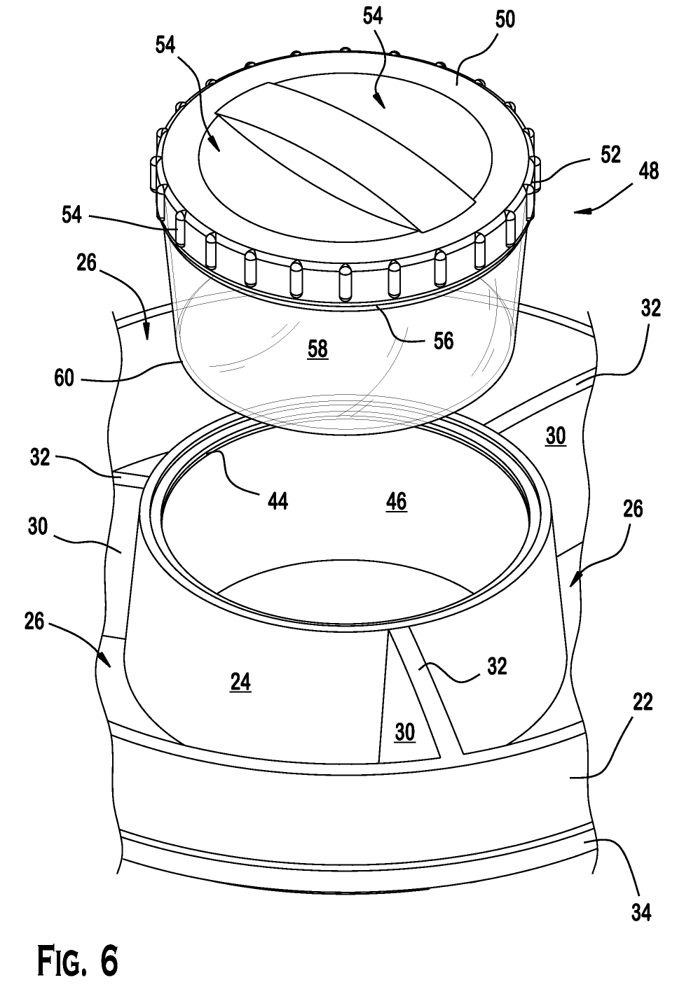

Referring to FIGS. 3 and 6, a tray 22 has at least one recess 26 defining at least one consumable receiving cavity 28. While the illustrated recesses 26 are symmetrically spaced about the tray 22, those of ordinary skill in the art will appreciate from this disclosure that any number and configuration of recesses can be used without departing from the scope of the present invention. For example, some recesses 26 can have a first shape (such as a wedge) while other recesses may have different shapes (such as square or trapezoidal). Furthermore, one, four, or any number of recesses 26 can be used with the present invention or the recesses 26 can be omitted altogether without departing from the scope of the present invention.

The tray preferably defines a plurality of recesses 26 adapted to receive consumables 76 that are partially bordered by dividers 30 that may have thermal energy storage 62 material therein. Referring to FIG. 4, the dividers 30 can be formed by a fold in an upper tray panel 40A. While the dividers 30 are shown as being fixed in position, they may be adjustable without departing from the scope of the present invention. The upper edge 32 of the dividers 30 is preferably generally coplanar with the top of the secondary bowl 24.

Referring to FIGS. 2 and 4, the tray 22 can be configured to be seated generally at least partially within and/or over the opening 70 of the main bowl 64. However, those of ordinary skill in the art will appreciate from this disclosure that any suitable mechanism or configuration for engaging the tray 22 with the main bowl 64 can be used without departing from the scope of the present invention. The tray can include a protrusion 34 adapted for placement on an edge 72 of the main bowl 64 so that at least a portion of the tray 22 is seated within and/or over the opening 70. It is preferable, but not necessary, that a lower half 36 of the tray is located inside the main bowl 64 when the tray 22 is engaged with the main bowl 64.

In an alternate embodiment, the tray 22 may be at least partially translucent and/or at least partially transparent. This can allow a color of the thermal energy storage material 62 to be seen through the tray. This can allow for highly customized an pleasing aesthetic effects.

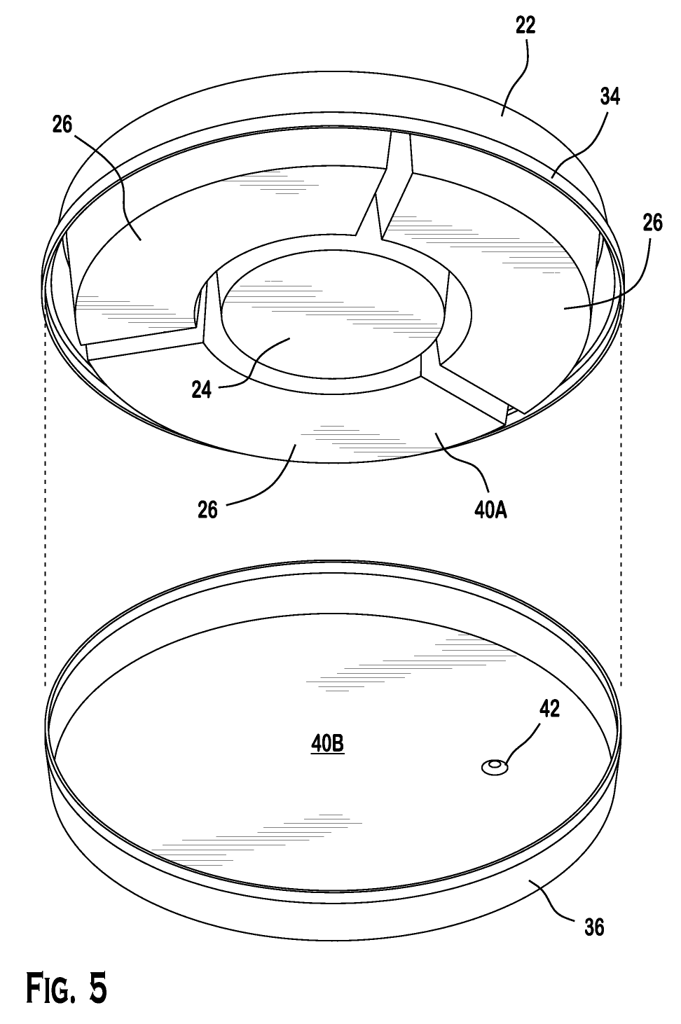

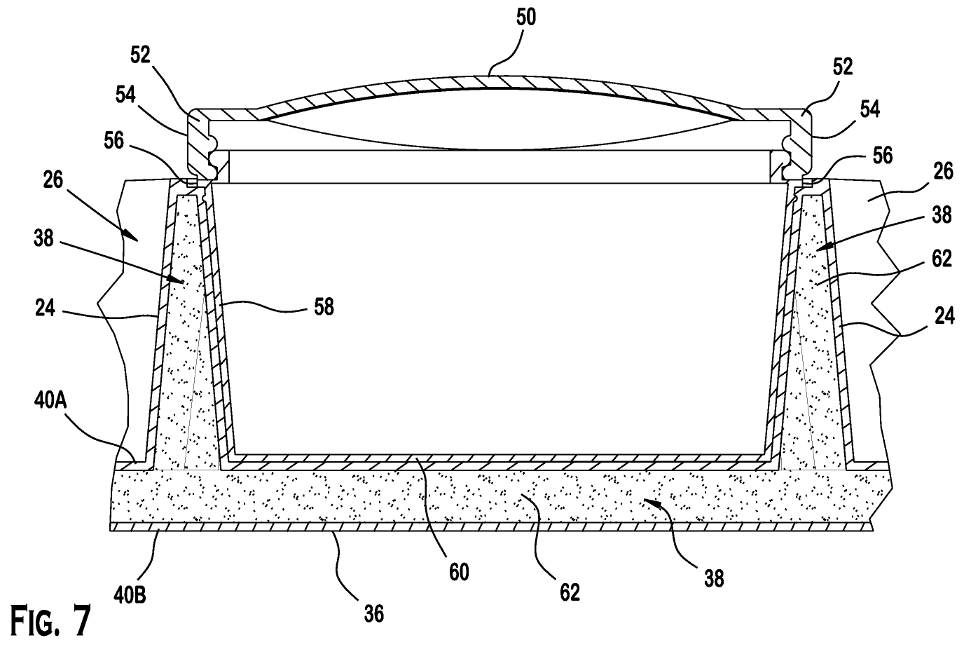

Referring to FIGS. 6 and 7, the secondary bowl 24 may be located in and/or adjacent to the at least one recess 26. Referring to FIG. 2, the at least one recess 26 may be configured to create the secondary bowl 24 generally centrally therein. The secondary bowl may be adapted to receive at least one of a consumable and a container 48 adapted to hold consumables therein. Referring to FIGS. 5 and 7, the secondary bowl 24 may be defined by the tray 22. An inner surface 46 of the secondary bowl 24 may have a groove 44 therein to facilitate engagement with the container 48 (further described below).

Referring specifically to FIG. 5, one method of manufacturing the tray 22 involves attaching first and second panels 40A and 40B. The panels can be secured together using heat welding, sonic welding, adhesive, or any other suitable method. Referring also to FIG. 7, the panels 40A, 40B may combine to form a chamber 38 to hold thermal energy storage material 62. The thermal energy storage material 62 may be injected into the tray 22 at an injection site 42 that is subsequently closed.

The thermal energy storage material 62 located in the tray 22 is adapted to heat and/or cool consumables 76. The thermal energy storage material can be located only in the secondary bowl 24 or can be in another or multiple discrete locations within the tray 22 without departing from the scope of the present invention. Alternatively, the system 10 may be free of thermal energy storage material 62 without departing from the scope of the present invention. While the thermal energy storage material 62 is shown as being permanently positioned inside of a sealed tray 22, the thermal energy storage material 62 may be configured as a removable insert. When the thermal energy storage material 62 is configured as a removable insert it is preferably located in a polymer pouch or container. However, any suitable material may be used to provide a casing for the removable insert without departing from the scope of the present invention. A detachable panel may allow access to the tray 22 to allow insertion and removal of the removable insert. The removable insert can be removed from the tray 22 and heated or cooled separately from the remainder of the tray 22, and can be inserted when consumables are placed into the container 10 and require maintenance at a given temperature.

Referring to FIGS. 1 and 2 a lid 12 may be adapted to cover the tray 22 and detachably engage the main bowl 64. The lid 12 is preferably generally circular, but may have any shape or configuration without departing from the scope of the present invention. The lip may include a lip 20 that extends generally downwardly to abut a ledge of the main bowl 64. The lid 12 can include at least one tab 16 extending therefrom. The at least one tab 16 may be adapted to engage the ledge 74 to detachably secure the lid 12 to the main bowl 64. The tab may include a ridge 18 that extends radially inwardly to engage the lower portion of the main bowl ledge 74 to detachably secure the lid 12 to the main bowl 64 with the lid top 14 covering the tray 22. The at least one tab 16 may be connected to the lid via a hinge, such as a living hinge 78.

Referring to FIGS. 6 and 7, the container 48 is preferably adapted to hold consumables 76 therein. The container may be detachably engaged with the secondary bowl 24. The container preferably has a complementary shape to that of the secondary bowl 24 to allow nesting therein. However, the container 48 may have any shape without departing from the scope of the present invention. The secondary bowl 24 and container 48 may be configured to detachably connect using at least one of an interference fit connection, a snap fit connection, and a twist-lock connection. However, those of ordinary skill in the art will appreciate from this disclosure that any suitable connection can be used. A snap fit connection is shown with a container flange 56 engaged with the groove 44 in the secondary bowl 24. When sufficient force is placed on the container 48 the flange 56 may be engaged or disengaged from the groove 44.

The container 48 may include a cover 50. As shown in FIG. 4, it is preferred that the container is configured such that the cover 50 is generally adjacent to an upper edge 32 of the tray 22 when the container 48 is engaged with the secondary bowl 24. As best shown in FIG. 6, the cover may define at least one groove 54 therein (i.e., in the cover 50) to form a handle. The cover may also include a grip 52 thereon. The grip is preferably formed by knobs located circumferentially around the side of the cover to facilitate twisting. The body 58 of the lid is preferably nestable against the inner surface 46 of the secondary bowl 24 so that the base 60 of the container 48 may rest on the bottom of the secondary bowl 24.

In an alternate embodiment, at least one of the main bowl 64 and the lid 12 are at least partially translucent and/or at least partially transparent. This can allow the tray 22 to be at least partially viewable while enclosed by the main bowl 64 and the lid 12. In yet another embodiment, the main bowl 64 and the lid 12 are each at least partially translucent and/or at least partially transparent so that the tray is at least partially viewable while enclosed by the main bowl 64 and the lid 12.

Referring to FIGS. 1-7, one embodiment of the present invention operates as follows. A person may place the tray in a freezer of the like to cause the thermal energy storage material 62 therein to cool. Then, consumables may be placed in the main bowl 64 and the tray positioned proximate the opening 70 of the main bowl. Additional consumables may be placed in recesses 26 in the tray 22 and/or in the secondary bowl 24. Alternatively, a container 48 adapted to hold consumables 76 may be positioned in the secondary bowl 24. Then, a lid 12 may be positioned over the tray 22 and engaged with the main bowl 64. A user is then free to carry the consumables in a convenient and ready to use fashion.

While various shapes, configurations, and features have been described above and shown in the drawings for the various embodiments of the present invention, those of ordinary skill in the art will appreciate from this disclosure that any combination of the above features can be used without departing from the scope of the present invention. Accordingly, it is recognized by those skilled in the art that changes may be made in the above described embodiments of the invention without departing from the broad inventive concept thereof. For example, the shape of the container, the relative dimensions of the container, the shape of the tray, the type of lid, the connection methods used, the material used as thermal energy storing material, the number and location of cavities adapted to receive consumables, and, if present, the location of the detachable panel may be changed without departing from the scope of the present invention. It is understood, therefore, that this invention is not limited to the particular embodiments disclosed, but is intended to cover all modifications which are within the spirit and scope of the invention as defined by the appended claims and/or shown in the attached drawings.

What is claimed is:

1. A system adapted to separately hold consumables, comprising:
a main bowl having an upper perimeter portion defining an opening;
a tray having at least one recess defining at least one consumable receiving cavity, the tray being configured to be seated generally at least partially within and/or over the opening of the main bowl;
a secondary bowl located in the at least one recess, the secondary bowl being adapted to receive at least one of a consumable and a container adapted to hold consumables therein;
thermal energy storage material located in the tray and adapted to heat and/or cool consumables; and
a lid adapted to cover the tray and detachably engage the main bowl.

2. The system of claim 1, wherein the secondary bowl is defined by the tray.

3. The system of claim 2, wherein the thermal energy storage material is located in the secondary bowl.

4. The system of claim 1, further comprising a the tray defining a plurality of recesses adapted to receive consumables.

5. The system of claim 4, wherein the plurality of recesses are partially bordered by dividers that have thermal energy storage material therein.

6. The system of claim 1, further comprising the container adapted to hold consumables therein, the container being detachably engaged with the secondary bowl.

7. The system of claim 6, wherein the secondary bowl and container are configured to detachably connect using a snap fit connection.

8. The system of claim 7, wherein the container further comprises a cover, the container being configured such that the cover is generally adjacent to an upper edge of the tray when the container is engaged with the secondary bowl.

9. The system of claim 9, wherein the cover defines at least one groove therein to form a handle, the cover further comprising a grip thereon.

10. The system of claim 1, wherein the tray includes a protrusion adapted for placement on an edge of the main bowl so that at least a portion of the tray is seated within and/or over the opening.

11. The system of claim 1, further comprising:
the main bowl having a ledge extending generally outwardly therefrom; and
the lid including at least one tab extending therefrom, the at least one tab being adapted to engage the ledge to detachably secure the lid to the main bowl.

12. The system of claim 11, wherein the at least one tab is connected to the lid via a hinge.

13. A system adapted to separately hold consumables, comprising:
a main bowl having an upper perimeter portion defining an opening;
a tray having at least one recess defining at least one consumable receiving cavity, the tray being configured to be seated generally at least partially within and/or over the opening of the main bowl;
a container adapted to hold consumables therein, the container being detachably engageable with the tray;
a secondary bowl located in the at least one recess, the secondary bowl being adapted to receive at least one of a consumable and the container adapted to hold consumables therein;
thermal energy storage material located in the tray and adapted to heat and/or cool consumables; and
a lid adapted to cover the tray and detachably engage the main bowl.

14. The system of claim 13, wherein the secondary bowl and container are configured to detachably connect using at least one of an interference fit connection, a snap fit connection, and a twist-lock connection.

15. The system of claim 14, wherein the container further comprises a cover, the container being configured such that the cover is generally adjacent to an upper edge of the tray when the container is engaged with the secondary bowl.

16. The system of claim 15, further comprising:
the main bowl having a ledge extending generally outwardly therefrom; and
the lid including at least one tab extending therefrom, the at least one tab being adapted to engage the ledge to detachably secure the lid to the main bowl.

17. The system of claim 16, wherein at least one of the main bowl and the lid are at least partially translucent and/or at least partially transparent, so that the tray is at least partially viewable while enclosed by the main bowl and the lid.

18. The system of claim 16, wherein the main bowl and the lid are each at least partially translucent and/or at least partially transparent so that the tray is at least partially viewable while enclosed by the main bowl and the lid.

19. A system adapted to separately hold consumables, comprising:
a main bowl having an upper perimeter portion defining an opening;
a tray having at least one recess defining at least one consumable receiving cavity, the tray being configured to be seated generally at least partially within and/or over the opening of the main bowl, the tray being at least partially translucent and/or at least partially transparent;
a container adapted to hold consumables therein, the container being detachably engageable with the tray;
a secondary bowl located in the at least one recess, the secondary bowl being adapted to receive at least one of a consumable and the container adapted to hold consumables therein;
thermal energy storage material located in the tray and adapted to heat and/or cool consumables;
a lid adapted to cover the tray and detachably engage the main bowl; and
wherein a color of the thermal energy storage material can be seen through the tray.

20. A system adapted to separately hold consumables, comprising:
a main bowl having an upper perimeter portion defining an opening, the main bowl having a ledge extending generally outwardly therefrom;
a tray having at least one recess defining at least one consumable receiving cavity, the tray being configured to be seated generally at least partially within and/or over the opening of the main bowl;
a container adapted to hold consumables therein, the container being detachably engageable with the tray;
a secondary bowl located in the at least one recess, the secondary bowl being adapted to receive at least one of a consumable and the container adapted to hold consumables therein;
thermal energy storage material located in the tray and adapted to heat and/or cool consumables; and
a lid comprising at least one tab extending therefrom, the at least one tab being adapted to engage the ledge to detachably secure the lid to the main bowl.

21. The system of claim 20, wherein the secondary bowl is defined by the tray.

22. The system of claim 21, wherein the thermal energy storage material is located only in portions of the tray that define the secondary bowl.

23. The system of claim 20, wherein the container further comprises a cover, the container being configured such that the cover is generally adjacent to an upper edge of the tray when the container is engaged with the secondary bowl.

24. The system of claim 23 wherein the tray includes a protrusion adapted for placement on an edge of the main bowl so that at least a portion of the tray is seated within and/or over the opening.
